(19) United States
(12) Patent Application Publication
(10) Pub. No.: US 2011/0121985 A1
(43) Pub. Date: May 26, 2011

(54) ELECTRONIC DEVICE

(76) Inventor: Nobuhiro Yamamoto, Tokyo (JP)

(21) Appl. No.: 12/813,254

(22) Filed: Jun. 10, 2010

(30) Foreign Application Priority Data
Nov. 24, 2009 (JP) 2009-266816

(51) Int. Cl. G08B 21/00; H02H 3/02

(52) U.S. Cl. 340/650; 361/78

(57) ABSTRACT

According to one embodiment, an electronic device, includes: a short-circuit mechanism configured to be provided with a potential difference between a first conductor and a second conductor, the first conductor and the second conductor being disposed on an insulator, the second conductor being disposed on the insulator apart from the first conductor by a predetermined clearance; a measuring module configured to measure, when the electronic device is activated, an electrical value between the first conductor and the second conductor; a detector configured to detect, when the electrical value is a preliminarily set electrical value, a short-circuit between the first conductor and the second conductor; a notifying module configured to notify, when the short circuit is detected, occurrence of the short-circuit; and an activation module configured to selectably activate or deactivate the electronic device when the short circuit is notified.

This application is based upon and claims the benefit of priority from Japanese Patent Application No. 2009-266816, filed on Nov. 24, 2009, the entire contents of which are incorporated herein by reference.

### FIELD

Embodiments described herein relate generally to an electronic device.

### BACKGROUND

Recently, there has been proposed a technology for systematically managing a product life cycle of an electronic device such as a personal computer (PC). In this technology, a printed circuit board is provided at a portion thereof with a pattern for detecting occurrence of short-circuit due to dew condensation or ion-migration, and when the occurrence of the short-circuit is detected at the time the electronic device is activated, the electronic device is deactivated (see for example Japanese Patent Application (KOKAI) No. 2001-251026).

However, according to the conventional technology, when the occurrence of the short-circuit is detected at the time the electronic device is activated, despite the user's intention the electronic device is deactivated and becomes unusable. For example, even when a point at which the occurrence of the short-circuit is detected and the electronic device is deactivated is set to be low, some users may desire to continue activating the electronic device at the time the occurrence of the short-circuit is detected. Further, user may desire to deactivate the electronic device after performing data backup or the like to the electronic device at the detection the occurrence of the short-circuit.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a portable computer comprising a conductor for detecting occurrence of short-circuit due to dew condensation, ion-migration, or the like, according to an embodiment;

FIG. 2 is an exemplary perspective diagram of the portable computer in the embodiment;

FIG. 3 is an exemplary schematic diagram of a short-circuit mechanism of dew condensation type in the embodiment;

FIG. 4 is an exemplary schematic diagram of a short-circuit mechanism of ion-migration type in the embodiment;

FIG. 5 is an exemplary schematic diagram illustrating n-migration in the embodiment;

FIG. 6 is another exemplary schematic diagram illustrating the ion-migration in the embodiment;

FIG. 7 is an exemplary schematic diagram for explaining the occurrence of the short-circuit in the short-circuit mechanism of the dew condensation type in the embodiment;

FIG. 8 is an exemplary schematic diagram for explaining the occurrence of the short-circuit in the short-circuit mechanism of the ion-migration type in the embodiment;

FIG. 9 is an exemplary schematic diagram of a conductor arranged on the circuit board in the embodiment,

FIG. 10 is an exemplary schematic diagram illustrating a position on the circuit board where the short-circuit mechanism of the ion-migration type is arranged in the embodiment;

FIG. 11 is an exemplary schematic diagram of the short-circuit mechanism of the dew condensation type arranged to a power connector in the embodiment;

FIG. 12 is an exemplary schematic diagram illustrating various arrangements of the conductor in the embodiment;

FIG. 13 is an exemplary block diagram of the portable computer in the embodiment;

FIG. 14 is an exemplary flowchart of activation process of the portable computer in the embodiment; and

FIG. 15 is an exemplary graph illustrating condition of the electronic device over time when the short-circuit is occurred due to the dew condensation, the ion-migration, or the like.

### DETAILED DESCRIPTION

In general, according to one embodiment, an electronic device comprises: a short-circuit mechanism, a measuring module, a detector, a notifying module, and an activation module. The short-circuit mechanism is configured to be provided with a potential difference between a first conductor and a second conductor due to a voltage applied to at least one of the first conductor and the second conductor. The first conductor and the second conductor are disposed on an insulator. The second conductor is disposed on the insulator apart from the first conductor by a predetermined clearance. The measuring module is configured to measure, when the electronic device is activated, an electrical value between the first conductor and the second conductor. The detector is configured to detect, when the electrical value is a preliminarily set electrical value, a short-circuit between the first conductor and the second conductor. The notifying module is configured to notify, when the short circuit is detected, occurrence of the short-circuit. The activation module is configured to selectably activate or deactivate the electronic device when the short circuit is notified.

According to another embodiment, an electronic device comprises: a conductor, a measuring module, a detector, a notifying module, and an activation module. The conductor comprises a separation with a distance that is to be short-circuited under a predetermined condition, and is conductive. The measuring module is configured to measure, when the electronic device is activated, an electrical value of the separation. The detector is configured to detect, when the electrical value is a preliminarily set electrical value, a short-circuit of the conductor. The notifying module is configured to notify, when the short-circuit is detected, occurrence of the short-circuit. The activation module is configured to selectably activate or deactivate the electronic device when the short-circuit is notified.

In the following, an embodiment of an electronic device is explained with reference to the drawings. In the embodiment, the electronic device is applied to a device such as a notebook personal computer (portable computer). However, the device is not limited thereto as long as the device requires a conductor for detecting occurrence of short-circuit due to dew condensation, ion-migration, or the like. For example, the electronic device can be applied to other devices such as a cell phone.

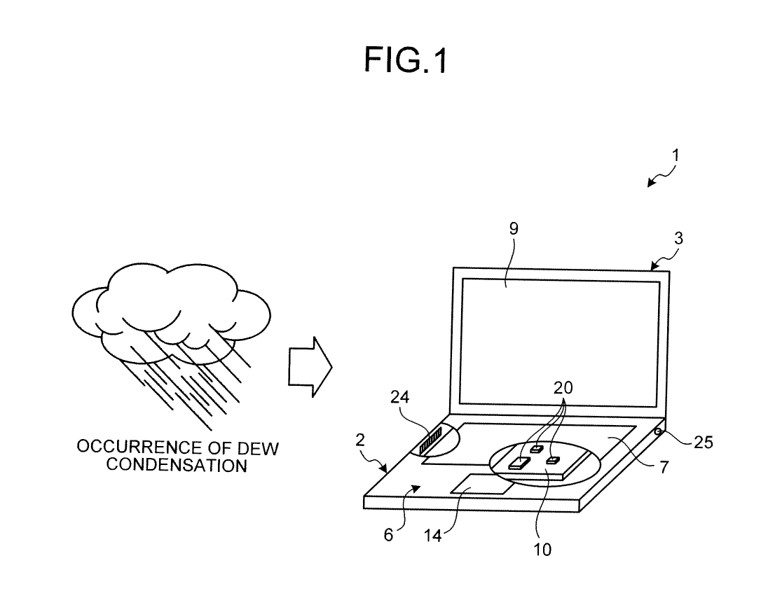

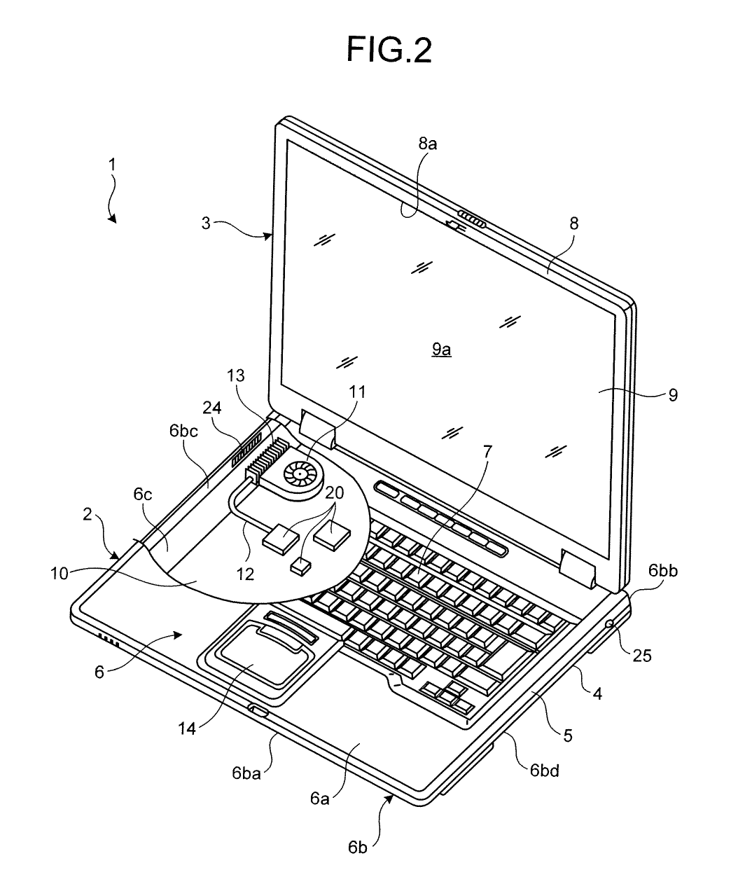

A schematic configuration of a portable computer comprising a conductor for detecting occurrence of short-circuit due to dew condensation, ion-migration, or the like is explained with reference to FIGS. 1 and 2. FIG. 1 is a schematic diagram of the portable computer comprising the conductor for detecting the occurrence of the short-circuit due to the dew condensation, the ion-migration, or the like. FIG. 2 is a perspective view of the portable computer comprising the conductor for detecting the occurrence of the short-circuit due to the dew condensation, the ion-migration, or the like.

A portable computer 1 according to the embodiment comprises a main body 2 and a display module 3.

The main body 2 comprises a base 4 and a cover 5. The cover 5 is assembled with respect to the base 4 from thereabove. The main body 2 has a housing 6 formed by the base 4 and the cover 5.

The housing 6 comprises an top wall 6a, a peripheral wall 6b, and a bottom wall 6c. The top wall 6a supports a keyboard 7 and a touch panel 14. The peripheral wall 6b comprises a front peripheral wall 6ba, a back peripheral wall 6bb, a left peripheral wall 6bc, and a right peripheral wall 6bd.

The display module 3 comprises a display housing 8 and a liquid crystal display (LCD) panel 9 housed in the display housing 8. The LCD panel 9 comprises a display screen 9a. The display screen 9a is exposed to outside of the display housing 8 via an opening portion 8a at a front face of the display housing 8.

The display module 3 is supported by a back end portion of the housing 6 via a hinge device. As a result, the display module 3 is capable of being rotated between a closed position in which the display module 3 is tipped down as to cover the top wall 6a from thereabove and an opened position in which the display module 3 stands as to expose the upper wall 6a to the outside.

The housing 6 houses therein an air blower device 11, a heat dissipating member 13, a heat pipe 12, and a circuit board 10. The air blower device 11 blows in gas. The heat dissipating member 13 dissipates heat by utilizing the gas supplied from the air blower device 11. The heat pipe 12 extends from the heat dissipating member 13, and transfers heat to the heat dissipating member 13. An electronic component 20 is mounted on the circuit board 10. In the embodiment, an outlet 24 for releasing the gas supplied by the air blower device 11 to outside of the housing 6 is arranged on the left peripheral wall 6bc so as to oppose to a position where the heat dissipating member 13 is housed. Further, a slot 25 is provided on the right peripheral wall 6bd. At the slot 25, a power connector (male) to which a power code is connected is inserted into a power connector (female) 117 housed in the housing 6.

The electronic component 20 may be, for example, a micro processing unit (MPU), a central processing unit (CPU), a graphics chip, various chipsets, or the like, for executing various control process of the portable computer 1.

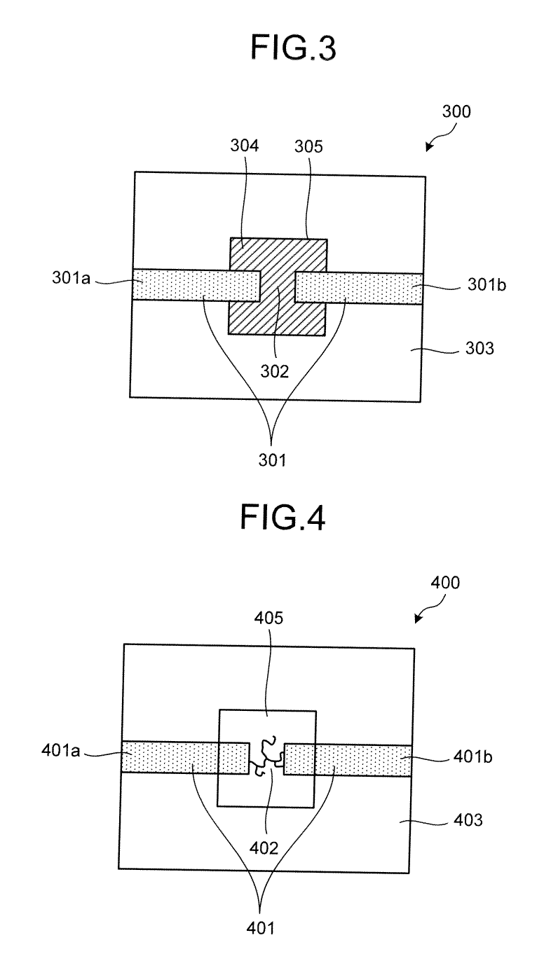

In the portable computer 1 according to the embodiment, at least one of a short-circuit mechanism 300 (illustrated in FIG. 3) for detecting the occurrence of the short-circuit due to the dew condensation and a short-circuit mechanism 400 (illustrated in FIG. 4) for detecting the occurrence of the short-circuit due to the ion-migration is arranged at a plurality of locations, such as for example: various types of interfaces such as the keyboard 7, the touch panel 14, or the LCD panel 9; the housing 6 forming the exterior of the portable computer 1; and/or near the position susceptible to water or the position where the moisture due to the dew condensation can easily be adhered, such as a position where the inside of the housing 6 is exposed to the outside. FIG. 3 is an example of a short-circuit mechanism of the dew condensation type, and FIG. 4 is an example of the short-circuit mechanism of the ion-migration type.

As illustrated in FIG. 3, the short-circuit mechanism 300 of the dew condensation type for alleviating the product load due to the short-circuit caused by moisture absorption, the dew condensation, or the like, comprises a conductor 301 arranged on an insulator 303. The conductor 301 comprises a separation 302 with a distance that is to be short-circuited under a predetermined condition such as when the dew condensation occurs or the moisture absorption occurs. A current flows through the conductor 301 when a voltage is applied thereto by a power source not illustrated. In other word, the short-circuit mechanism 300 comprises a first conductor 301a and a second conductor 301b arranged on the insulator 303. The second conductor 301b is disposed on the insulator 303 so as to be placed apart from the first conductor 301a by certain clearance. A potential difference is generated between the first conductor 301a and the second conductor 301b when a voltage is applied on at least one of the first conductor 301a and the second conductor 301b by the power supply not illustrated. In the following, the first conductor 301a and the second conductor 301b are referred to as the conductor 301.

In the embodiment, a portion of the conductor 301 is exposed to outside as an exposed portion 305. The conductor 301 is formed of a conductive material in which ion-migration rarely occurs, such as gold (Au), nickel (Ni), tin (Sn), various types of overlays, various types of wirings, and conductive adhesive. In the conductor 301, it is preferred to arrange a moisture absorption material 304 for facilitating moisture absorption at the exposed portion 305, or at a position of the portable computer 1 where moisture can easily be absorbed. In the embodiment, the conductor 301 is arranged: on various types of interfaces such as the keyboard 7, the touch panel 14, or the LCD panel 9; on the housing 6 forming the exterior of the portable computer 1; and/or near the position susceptible to water or the position where the moisture due to the dew condensation can easily be adhered, such as the position where the inside of the housing 6 is exposed to the outside.

When the short-circuit is caused in the conductor 301 due to the dew condensation, the portable computer 1 may be dried to remove the dew or absorbed moisture from the separation 302 (between the first conductor 301a and the second conductor 301b).

The short-circuit mechanism 400 of the ion-migration type is for prompting the user to perform data backup or repairing before a product is completely destroyed due to the short circuit caused by the ion-migration. The short-circuit mechanism 400 comprises a conductor 401 arranged on an insulator 403. The conductor 401 has a separation 402 with a distance to be short-circuited under a predetermined condition such as when the ion-migration is caused. Current flows through the conductor 401 when a voltage is applied by the power source not illustrated. In other word, in the short-circuit mechanism 400, a first conductor 401a and a second conductor 401b are arranged on the insulator 403. On the insulator 403, the second conductor 401b is disposed so as to be placed apart from the first conductor 401a by certain distance. A potential difference is generated between the first conductor 401a and the second conductor 401b when a voltage is applied to at least one of the first conductor 401a and the second conductor 401b by a power source not illustrated. In the following, the first conductor 401a and the second conductor 401b are referred to as the conductor 401.

In the embodiment, a portion of the conductor 401 is exposed to the outside as exposed portion 405. The conductor 401 is formed of a conductive material in which the ion-migration easily occurs, such as silver (Ag) and palladium silver (PdAg) alloy. Consequently, the user can be warned before the short-circuit is caused in the portable computer 1. In view of the fact that the ion-migration easily occurs with respect to the dew condensation, the conductor 401 is arranged at a position where the short-circuit is desired to be cautiously prevented. For example, the conductor 401 is arranged on the circuit board 10 housed in the housing 6, or inside the housing 6.

When the short-circuit due to the ion-migration occurs in the conductor 401, repairing such as removing the ion-migration occurred at the separation 402 (between the first conductor 401a and the second conductor 401b) can be performed.

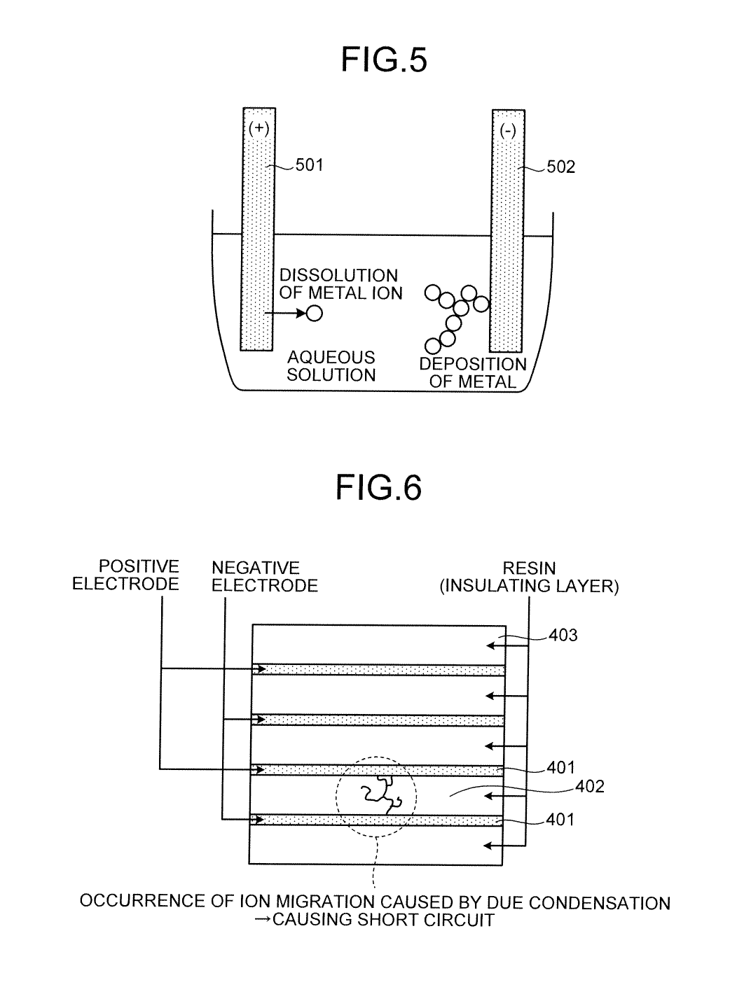

In the following, the ion-migration is explained with reference to FIGS. 5 and 6. FIGS. 5 and 6 illustrate the ion-migration. The ion-migration is a phenomenon that causes short-circuit between electrodes, due to deposition of metal caused when the metal is placed under high moisture environment or when the dew condensation is occurred. For example, as illustrated in FIG. 5, when a positive electrode 501 and a negative electrode 502 are placed in aqueous solution, the metal ions of the electrodes 501, 502 are dissolved and the ions moves between the electrodes. In terms of the print circuit board, as illustrated in FIG. 6, the ion-migration occurs between (in the separation 402) the positive electrode (conductor 401) and the negative electrode (conductor 401) disposed on the print circuit board as the wirings, so that the short-circuit is caused between the electrodes (conductor 401). Here, the insulator 403 is arranged between the positive and the negative electrodes.

As described above, the portable computer 1 according to the embodiment comprises the two types of short-circuit mechanisms: the short-circuit mechanism 300 of the dew condensation type; and the short-circuit mechanism 400 of the ion-migration type.

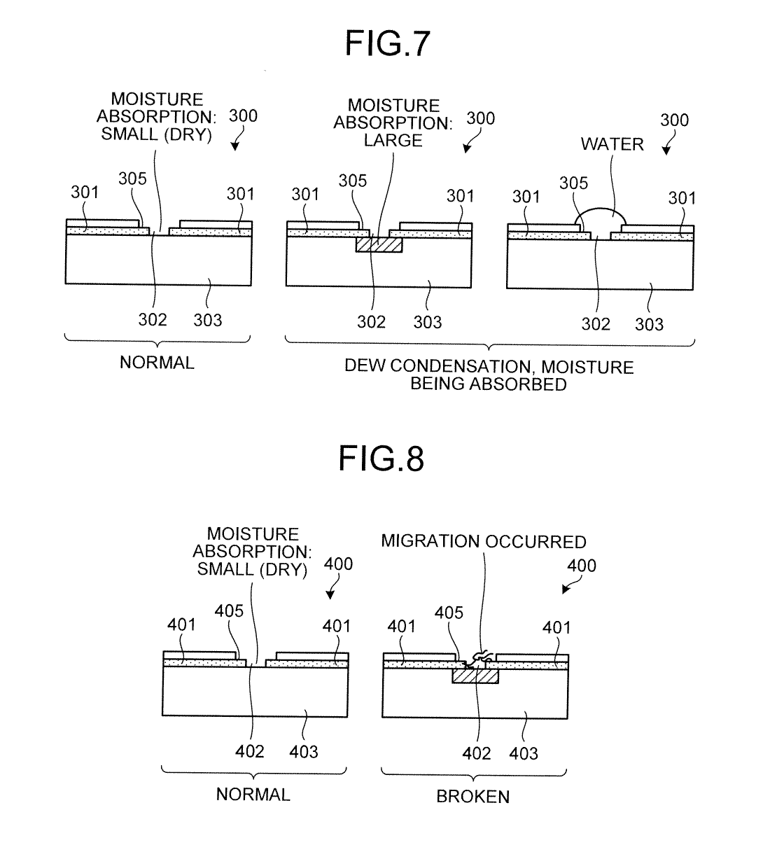

A mechanism of the cause of the short-circuit in each of the conductors 301, 401 is explained. FIG. 7 is a diagram for explaining the mechanism of the cause of the short-circuit in the short-circuit mechanism of the dew condensation type. FIG. 8 is a diagram for explaining the mechanism of the cause of the short circuit in the short-circuit mechanism of the ion-migration type.

As illustrated in FIG. 7, in the conductor 301, when an amount of the moisture absorption at the separation 302 (between the first conductor 301a and the second conductor 301b) is small or when the separation 302 is dry, the short-circuit is not caused at the separation 302 because the insulation resistance of the separation 302 is high. Hence, normal operation of the portable computer 1 is ensured. On the other hand, as illustrated in FIG. 7, in the conductor 301, when the amount of moisture absorbed at the separation 302 (between the first conductor 301a and the second conductor 301b) or when dew is condensed at the separation 302, the insulation resistance of the separation 302 becomes low. Accordingly, the short-circuit is caused at the separation 302.

As illustrated in FIG. 8, in the conductor 401, when the amount of the moisture absorbed at the separation 402 (between the first conductor 401a and the second conductor 401b) is small or when the separation 402 is dry, the short-circuit is not caused at the separation 402 because the insulation resistance of the separation 402 is high (current of the separation 402 is low). Accordingly, the normal operation of the portable computer 1 is secured. On the other hand, as illustrated in FIG. 8, in the conductor 401, when the amount of the moisture absorbed by the separation 402 (between the first conductor 401a and the second conductor 401b) becomes large and the ion-migration occurs, the insulation resistance of the separation 402 becomes low (the current of the separation 402 becomes high). Accordingly, the short-circuit is caused at the separation 402.

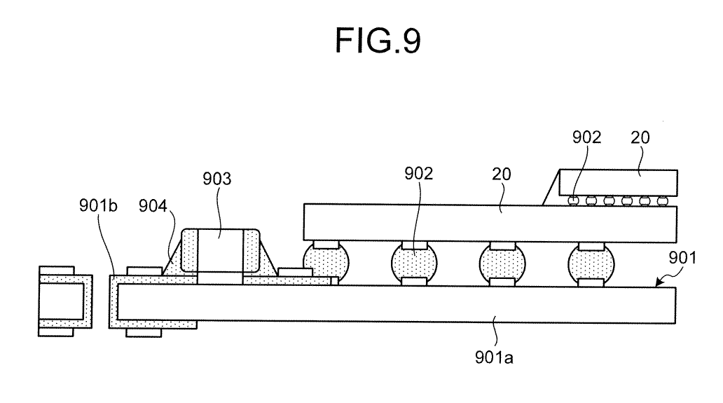

Next, with reference to FIG. 9, an arrangement of the conductor 401 on the circuit board 10 is explained. FIG. 9 is an example of an arrangement of the conductor on the circuit board.

In order to cause the short-circuit at, for example, the external interface where generally not many conductors are arranged, a new conductor is required as the conductor 401 to be arranged at the external interface. When a conductor is already arranged at a position for which the short-circuit is desired to be caused, the conductor 401 is arranged without providing the new conductor as the conductor 401.

For example, FIG. 9 illustrates a printed circuit board 10 as the circuit board 10. In the printed circuit board, the electronic component 20, a chip component 903, and/or the like are soldered onto and connected to a base plate 901 in which a printed pattern is formed on an insulating board (insulator) 901a by a conductor 901b such as a copper overlay, by a solder ball 902 and the like. In such printed circuit board 10, the conductors disposed on the circuit board 10, such as the conductor 901b, the solder ball 902, the chip component 903, and a solder 904 connecting the chip component 903 and the conductor 901b, can be used as the conductor 401. Then, this conductor 401 can be used to measure the insulation resistance (or inter-conductor current) in the conductor (between the first conductor 401a and the second conductor 401b) so that the short-circuit in the circuit board 10 can be detected.

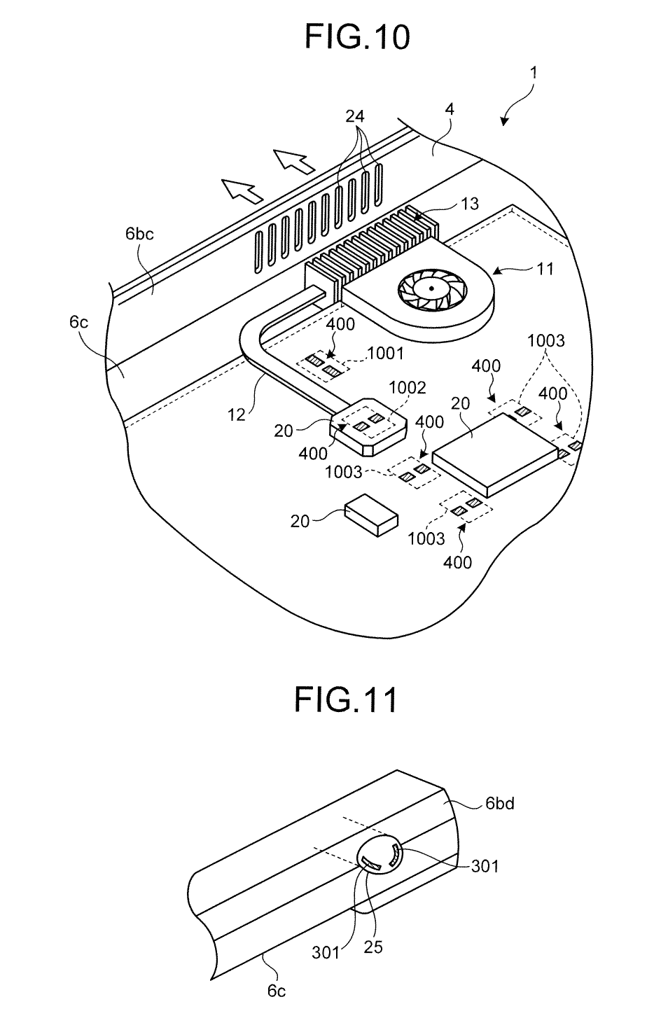

FIG. 10 is a diagram of an arrangement of the short-circuit mechanism of the ion-migration type arranged on a circuit substrate. It is preferred to arrange the short-circuit mechanism 400 at a position where temperature changes frequently due to heat generation by the electronic component 20, heat transfer by the heat pipe 12, and/or heat dissipation by the heat dissipating member 13. For example, as illustrated in FIG. 10, the short-circuit mechanism 400 is arranged at a position 1001 near the position where the heat pipe 12 is arranged, a position 1002 on an upper face of the electronic component 20 mounted on the circuit board 10, and/or a position 1003 at least one of the four corners 4 of the electronic component 20 mounted on the circuit board 10.

FIG. 11 is a diagram of the short-circuit mechanism of the dew condensation type arranged for the power connector. The conductor 301 to be arranged near the slot 25 is arranged on a wall of the slot 25 at a side of the bottom wall 6c of the housing 6.

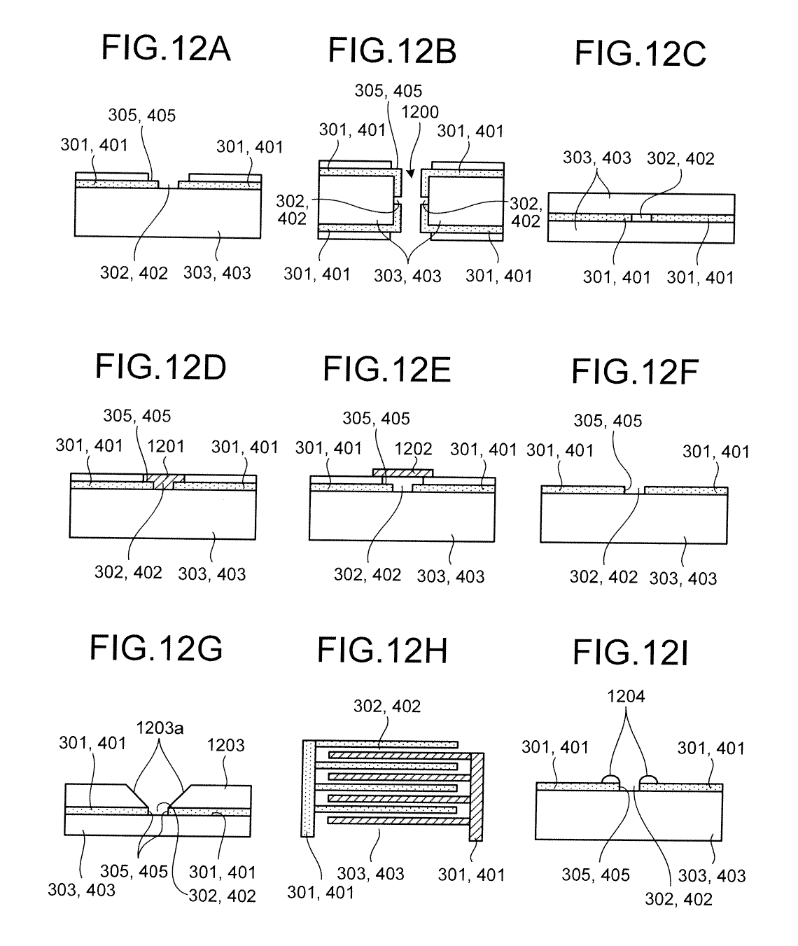

Various arrangements of the conductor 301 and the conductor 401 are explained with reference to FIG. 12. FIGS. 12A to 12I are diagrams of various arrangements of the conductors.

The conductors 301, 401 illustrated in FIG. 12A has the same structure as that of the conductors 301, 401 illustrated in FIGS. 3 and 4.

The conductors 301, 401 illustrated in FIG. 12B are arranged in a through hole 1200 of the circuit board 10, and the portions of the conductors 301, 401 are exposed to the outside as the exposed portions 305, 405

In FIG. 12C, a conductor disposed in an inner layer of the circuit board 10 through the insulator is used as the conductors 301, 401. This is because, although a conductor such as a circuit pattern is disposed in the inner layer of the circuit board 10, the dew and the like may be infiltrated into the circuit board 10 from between the insulating layer and the circuit pattern of the circuit board 10. Such infiltration may cause the short-circuit in the inner layer of the circuit board 10, due to the dew condensation, ion-migration, or the like.

The conductors 301, 401 illustrated in FIG. 12D comprises the exposed portions 305, 405 where portions of the conductors 301, 401 are exposed. A moisture absorption material 1201 that readily absorbs the moisture is arranged at the exposed portions 305, 405. As a result, the conductors 301,401 are to be arranged at a position in the portable computer 1 where the moisture is easily absorbed. Consequently, the short-circuit at this position can be detected before short-circuit occurs at other locations, thereby the product quality of the portable computer 1 as a whole can further easily be maintained.

The conductors 301, 401 illustrated in FIG. 12E comprises exposed portions where portions of the conductors 301, 401 are exposed to the outside, and an anisotropic infiltrate coating layer 1202 that barely dries, such as GORE-TEX (registered trademark), is arranged at the exposed portions. In other words, the conductors 301, 401 are to be arranged at a position in the portable computer 1 where is rarely dry. Consequently, the short-circuit at this position can be detected before short-circuit occurs at other locations, so that the product quality of the portable computer 1 as a whole can further easily be maintained.

The conductors 301, 401 illustrated in FIG. 12F use a conductive adhesive. Consequently, it becomes possible to provide the conductors 301, 401 anywhere in the portable computer 1. In addition, by changing the types of the metal particles included in the conductive adhesive, the lifetime of detection of the short-circuit due to the ion-migration or the like can easily be changed.

The conductors 301, 401 illustrated in FIG. 12G comprises the exposed portions 305, 405 where portions of the conductors 301, 401 are exposed to the outside. The portions of the conductors 301, 401 are exposed by a hole 1203a provided by a mold member 1203 covering the conductors 301, 401. The hole 1203a has upside down truncated cone shape. As a result, dew can intentionally be collected by the structure of the conductors 301, 401. Consequently, the short-circuit of the conductors 301, 401 can be detected before the short-circuit is caused at other locations, so that the product quality of the portable computer 1 as a whole can further easily be maintained.

In the conductors 301, 401 illustrated in FIG. 12H, a plurality of conductors are alternately arranged. The conductors may alternately be arranged in a thickness direction of the location where the conductors are provided, or may alternately be arranged on a surface of the location where the conductors are provided.

The conductors 301, 401 illustrated in FIG. 12I comprises the exposed portions 305, 405 where portions of the conductors 301, 401 are exposed. A material of the exposed portions is different from materials of other sections of the conductors 301, 401. For example, a plating or a conductive adhesive 1204 may be used as the material of the exposed portions. As a result, the lifetime of the detection of the short-circuit due to the ion-migration or the like can easily be changed. Further, by using the conductive adhesive 1204 as the exposed portions 305, 405, the clearance of the separations 302, 402 of the conductors 301, 401 can easily be narrowed down. Consequently, the short-circuit of the conductors 301, 401 can be detected before the short-circuit is caused at other locations, so that the product quality of the portable computer 1 as a whole can further easily be maintained.

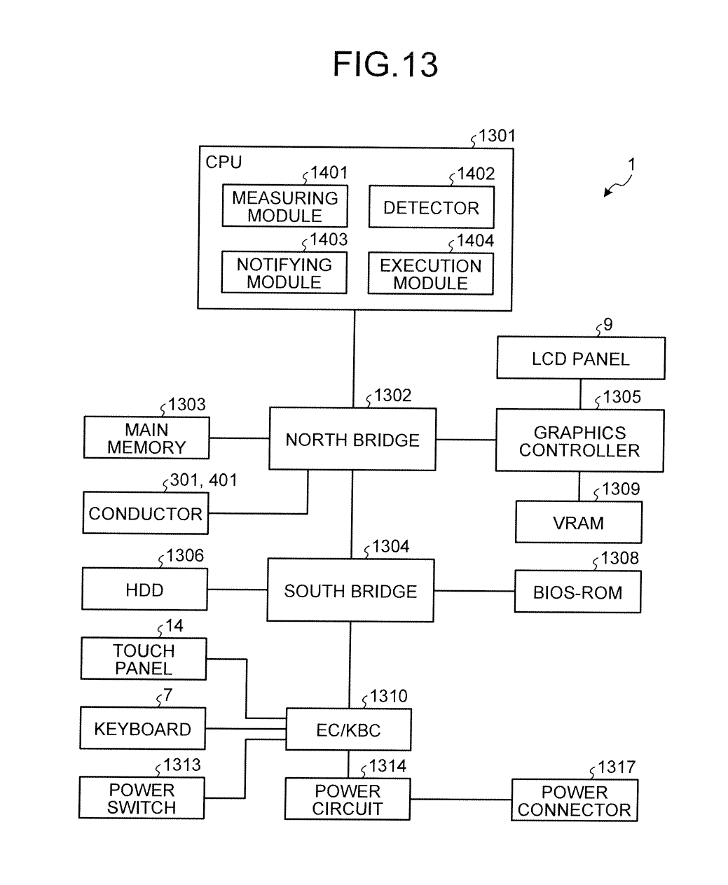

A hardware configuration of the portable computer 1 according to the embodiment is explained with reference to FIG. 13. FIG. 13 is a diagram illustrating a hardware configuration of the portable computer 1 according to the embodiment. As illustrated in FIG. 13, the portable computer 1 comprises the conductors 301, 401, a central processing unit (CPU) 1301, a north bridge (NB) 1302, a main memory 1303, a south bridge (SB) 1304, a graphics controller (GPU) 1305, a hard disk drive (HDD) 1306, the LCD panel 9, a basic input output system-read only memory (BIOS-ROM) 1308, a video random access memory 1309, an embedded controller/keyboard controller (EC/KBC) 1310, the touch panel 14, the keyboard 7, a power switch 1313, a power circuit 1314, and a power connector 1317.

The CPU 1301 is a processor that is configured to control operations of the portable computer 1, and executes an operating system (OS) loaded to the main memory 1303 from the HDD 1306. Further, the CPU 1301 executes a system BIOS stored in the BIOS-ROM 1308. The system BIOS is a program for hardware control. Functional features of the CPU 1301 according to the embodiment are explained later.

The north bridge 1302 is a bridge device configured to connect between a local bus of the CPU 1301 and the SB 1304. A memory controller configured to control access to the main memory 1303 is embedded in the main memory 1303. A controller configured to mediate the measurement of the electrical value such as the current or the insulation resistance of the separations 302, 402 (between the first conductors 301a, 401a and the second conductors 301b, 401b) of the aforementioned conductors 301, 401 is embedded in the NB 1302. The NB 1302 performs communication with the graphics controller 1305 through an accelerated graphics port (ASP) bus, a serial bus in compliance with a peripheral component interconnect (PCI) express standard, and the like.

The graphics controller 1305 is a display controller configured to control the LCD panel 9. The graphics controller 1305 is a display controller configured to control the LCD panel 9 used as a display monitor of the portable computer 1. The graphics controller 1305 transfers video signals stored in the VRAM 1309 by the OS or the application program to the LCD panel 9. The video signals are to be display information.

The SB 1304 controls each of the devices on a low pin count (LPC) bus and each of devices on a peripheral component interconnect (PCI) bus. An integrated drive electronics (IDE) controller for controlling the HDD 1306 is embedded on the SB 1304.

The EC/KBC 1310 is a one chip microcomputer in which an embedded controller for power management and a keyboard controller controlling the touch panel 14, the keyboard 7, and the like are integrated. The EC/KBC 1310 executes, in cooperation with the power circuit 1314, a process to power on or power off the portable computer 1 in response to the power switch 1313 operated by the user.

The power circuit 1314 generates power to be supplied to each component within the portable computer 1 by using the power supplied from outside via the power connector 1317.

Next, technical features of the CPU 1301 are explained.

As illustrated in FIG. 13, the CPU 1301 according to the embodiment comprises a measuring module 1401, a detector 1402, a notifying module 1403, and an execution module 1404.

When the portable computer 1 is activated, the measuring module 1401 measures an electrical values such as the insulation resistance of or the current through the separations 302, 402 (between the first conductors 301a, 401a and the second conductors 301b, 401b) of the conductors 301, 401, through the NB 1302.

When electrical value measured by the measuring module 1401 is a preliminarily set electrical value such as the insulation resistance or the current, the detector 1402 detects the occurrence of the short-circuit due to the dew condensation or the ion-migration in the conductors 301, 401.

In the embodiment, when the insulation resistance measured by the measuring module 1401 is less than a preliminarily set insulation resistance (for example, 1×10⁶Ω used in reliability assessment), the detector 1402 detects the occurrence of the short-circuit due to the dew condensation in the conductor 301. The preliminarily set insulation resistance is a value for confirming whether the housing 6 of the portable computer 1 is not wet, and the user can arbitrarily set this value.

When the insulation resistance measured by the measuring module 1401 is less than a preliminarily set insulation resistance (for example, 1×10⁴Ω), a detector 1042 detects the occurrence of the short-circuit due to the ion-migration in the conductor 401. Alternatively, when the current measured by the measuring module 1401 is greater than or equal to the preliminarily set current, the detector 1402 detects the occurrence of the short-circuit due to the dew condensation in the conductor 401. The preliminarily set insulation resistance or the current for detecting the occurrence of the short-circuit due to the ion-migration is a value for confirming whether the ion-migration is not being occurred (for example, certain threshold is not reached by a value for confirming that the overall environmental load of the portable computer 1), and the value can arbitrarily be set by the user.

When the short-circuit is detected by the detector 1402, the notifying module 1403 controls the graphics controller 1305 to display a massage on the LCD panel 9. As a result, the notifying module 1403 notifies the user of the short-circuit in the conductors 301, 401.

For example, when the short-circuit detected by the detector 1402 is due to the dew condensation, the notifying module 1403 controls the graphics controller 1305 to display a massage such as a massage prompting the user to select whether or not to activate the portable computer 1, a massage prompting the user to perform maintenance such as drying, or a massage notifying the user that the product warranty is to be void when the portable computer 1 is activated, on the LCD panel 9 to notify the user of the short-circuit caused in the conductor 301. On the other hand, when the short-circuit detected by the detector 1402 is due to the ion-migration, the notifying module 1403 controls the graphics controller 1305 to display a massage such as a massage prompting the user to select whether or not to activate the portable computer 1, a massage prompting the user to perform maintenance such as backup or repair, or a massage notifying the user that the product warranty is to be void when the portable computer 1 is activated, on the LCD panel 9 to notify the user of the short-circuit caused in the conductor 401.

When the occurrence of the short-circuit is notified by the notifying module 1403, the execution module 1404 selectably executes activation or deactivation of the portable computer 1 in accordance with the operation of the external interface or the like for selecting the activation or the deactivation of the portable computer 1. Further, when the portable computer 1 is deactivated or activated, the execution module 1404 stores the electrical value such as the insulation resistance or the current measured within a preliminarily set period (for example, a period from when the portable computer 1 is initialized until when the portable computer 1 is activated one hundred times) by the measuring module 1401, in a storage module such as the main memory 1303 or the HDD 1306, as a log.

When the sum of the insulation resistance represented by the log stored in the HDD 1306 reaches a preliminarily set value, the notifying module 1403 may control the graphics controller 1305 to prompt the user to select whether to activate the portable computer 1 by displaying, on the LCD panel 9, massages such as a massage prompting the user to select whether to activate the portable computer 1, a massage prompting the user to perform maintenance such as drying, or a massage indicating that the product warranty is to be void if the portable computer 1 is activated.

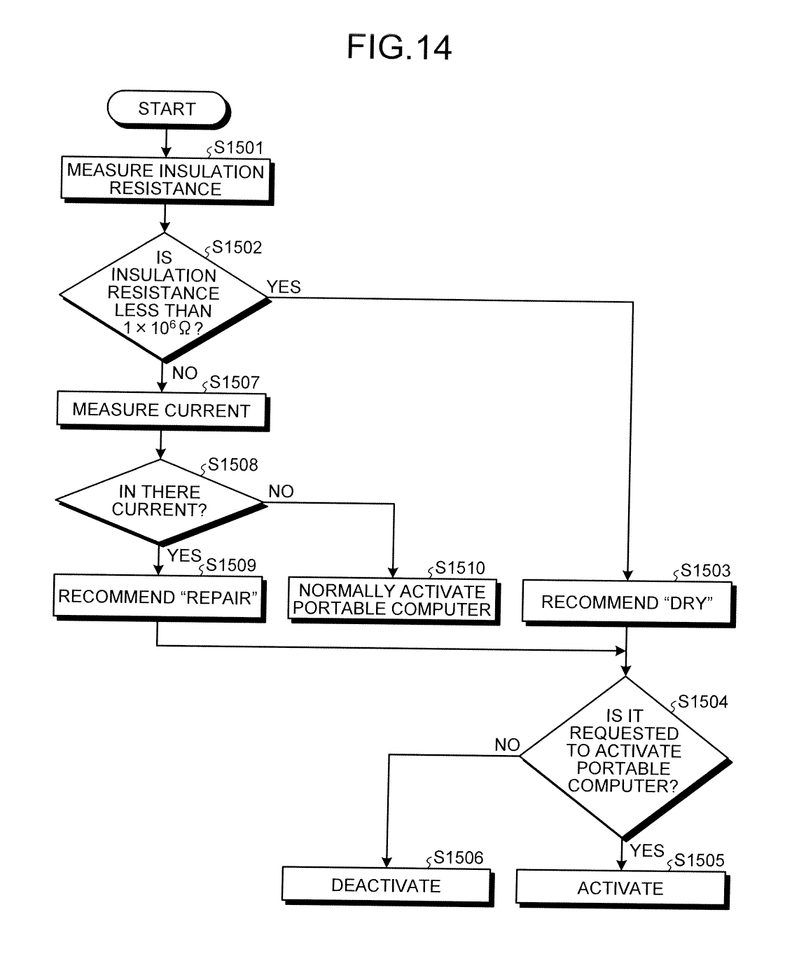

An activation process of the portable computer 1 is explained with reference to FIG. 14. FIG. 14 is a flowchart of the activation process of the portable computer 1.

When the system BIOS is executed by the CPU 1301 and the activation process of the portable computer 1 is executed, the measuring module 1401 measures the insulation resistance of the separation 302 (between the first conductor 301a and the second conductor 301b) of the conductor 301 (S1501). Then, the detector 1402 determines whether the insulation resistance measured by the measuring module 1401 is less than the preliminarily set insulation resistance of 1×10⁶Ω (S1502). When it is determined that the measured insulation resistance is less than the preliminarily insulation resistance (Yes at S1502), the detector 1402 detects the short-circuit in the conductor 301 due to the dew condensation. When the short-circuit is detected by the detector 1402, the notifying module 1403 displays the massage recommending drying, and notify the user of the occurrence of the short-circuit (S1503). Further, the execution module 1404 waits for the selection of whether the portable computer 1 is to be activated (S1504).

When it is selected to activate the portable computer 1 (Yes at S1504), the execution module 1404 activates the portable computer 1, and also stores the measured insulation resistance in the HDD 1306 as the log (S1505). On the other hand, when it is not selected to activate the portable computer 1 (No at S1504), the execution module 1404 deactivates the portable computer 1, and also stores the measured insulation resistance in the HDD 1306 as the log (S1506).

When it is determined that the measured insulation resistance is greater than or equal to the preliminarily set resistance value of 1×10⁶Ω (No at S1502), the detector 1402 determines that there is no occurrence of the short-circuit in the conductor 301 due to the dew condensation. Next, the measuring module 1401 measures the current of the separation 402 (between the first conductor 401a and the second conductor 401b) of the conductor 401 (S1507). The detector 1402 determines whether the measured current is greater than or equal to the preliminarily set current (S1508). When it is determined that the measured current is greater than or equal to the preliminarily set current (Yes at S1508), or in other words, when it is determined that the current flows through the separation 402, the detector 1402 detects the short-circuit in the conductor 401 due to the ion-migration. When the short-circuit due to the ion-migration is detected by the detector 1402, the notifying module 1403 displays the massage recommending the user the repairing to notify the user of the occurrence of the short-circuit (S1509), and proceed to S1504 to S1506. On the other hand, when the measured current is less than the preliminarily set current (No at S1508), or in other words, when it is determined that no current flows through the separation 402, the execution module 1404 normally activates the portable computer 1, and also stores the measured current in the HDD 1306 as the log (S1510).

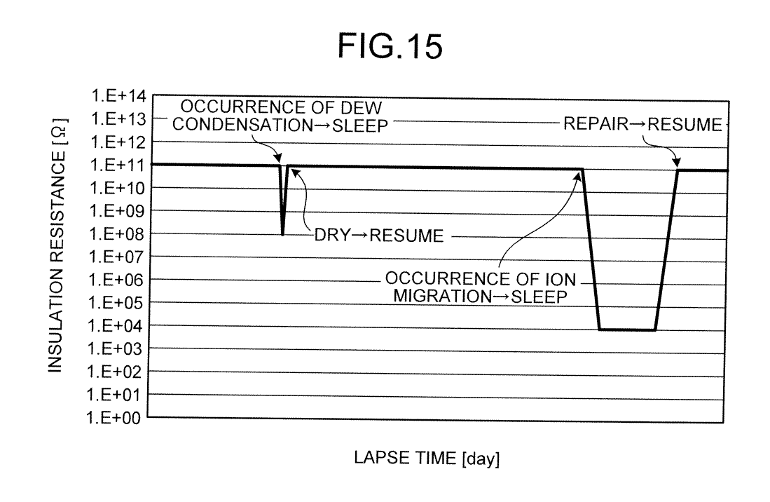

FIG. 15 is a time chart until the electronic device is recovered when the occurrence of the short-circuit due to the dew condensation, the ion-migration, or the like is detected. Conventionally, as illustrated in FIG. 15, when the occurrence of the short-circuit due to the dew condensation, the ion-migration, or the like is detected, the electronic device is deactivated (in sleep) independently of the user's intention. Accordingly, the electronic device cannot be used until it is dried, repaired, or the like.

On the other hand, according to the portable computer 1 of the embodiment, when the portable computer 1 is activated, the electrical value of the separations 302, 402 (between the first conductors 301a, 401a and the second conductors 301b, 401b) of the conductors 301, 401 are measured. Then, when the measured electrical value is the preliminarily set electrical value, the short-circuit in the conductors 301, 401 is detected. Then, when the occurrence of the short-circuit in the conductors 301, 401 is detected, the occurrence of the short-circuit in the conductors 301, 401 is notified. Then, when the occurrence of the short-circuit in the conductors 301, 401 is notified, the activation or the deactivation of the portable computer 1 is selectably executed. Consequently, when the occurrence of the short-circuit due to the dew condensation, the ion-migration, or the like is detected, the user can select whether to activate the portable computer 1. Accordingly, when the short-circuit is detected at the time the portable computer 1 is activated, it can be prevented to abort the activation of the portable computer 1 despite the user's intention.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device, comprising:
a short-circuit mechanism configured to be provided with a potential difference between a first conductor and a second conductor due to a voltage applied to at least one of the first conductor and the second conductor, the first conductor and the second conductor being disposed on an insulator, the second conductor being disposed on the insulator apart from the first conductor by a predetermined clearance;
a measuring module configured to measure, when the electronic device is activated, an electrical value between the first conductor and the second conductor;
a detector configured to detect, when the electrical value is a preliminarily set electrical value, a short-circuit between the first conductor and the second conductor;
a notifying module configured to notify, when the short-circuit is detected, occurrence of the short circuit; and
an activation module configured to selectably activate or deactivate the electronic device when the short circuit is notified.

2. An electronic device, comprising:
a conductor comprising a separation with a distance that is to be short-circuited under a predetermined condition, and is conductive;
a measuring module configured to measure, when the electronic device is activated, an electrical value of the separation;
a detector configured to detect, when the electrical value is a preliminarily set electrical value, a short-circuit of the conductor;
a notifying module configured to notify, when the short-circuit is detected, occurrence of the short-circuit; and
an activation module configured to selectably activate or deactivate the electronic device when the short-circuit is notified.

3. The electronic device of claim 2, wherein the conductor is disposed on a circuit board housed in a housing.

4. The electronic device of claim 2, wherein the conductor is disposed to an inner layer of a circuit substrate housed in a housing.

5. The electronic device of claim 2, wherein the conductor is disposed to an external interface.

6. The electronic device of claim 2, wherein the conductor is disposed near a position where an interior of a housing is exposed to an exterior.

7. The electronic device of claim 2, wherein the conductor comprises an exposed portion at a portion thereof, and a hygroscopic material is arranged to the exposed portion.

8. The electronic device of claim 2, wherein the conductor comprises a plurality of conductors.

9. The electronic device of claim 2, wherein the short-circuit of the conductor is occurred due to ion-migration.

10. The electronic device of claim 2, wherein the notifying module is configured to display a massage on a display module to notify the occurrence of the short-circuit.

11. The electronic device of claim 2, wherein
the measuring module is configured to measure an insulation resistance of the separation as the electrical value, and
the notifying module is configured to notify, when a sum of insulation resistances measured by the measuring module reaches a preliminarily set value within a preliminarily set period, the occurrence of the short-circuit.
